(19) United States
(12) Patent Application Publication
(10) Pub. No.: US 2015/0156447 A1
(43) Pub. Date: Jun. 4, 2015

(54) CURVED DISPLAY APPARATUS FOR VEHICLE

(71) Applicant: Hyundai Motor Company, Seoul (KR)

(72) Inventor: Jong Bok LEE, Yongin-si (KR)

(73) Assignee: Hyundai Motor Company, Seoul (KR)

(21) Appl. No.: 14/226,156

(22) Filed: Mar. 26, 2014

(30) Foreign Application Priority Data
Dec. 2, 2013 (KR) 10-2013-0148729

(51) Int. Cl. H04N 5/74; G06F 3/042

(52) U.S. Cl. CPC H04N 5/7458; G06F 3/0421

(57) ABSTRACT

A curved display apparatus for a vehicle includes a laser scanning projector projecting an image onto a predetermined projection area. A first plane mirror is configured to reflect the image projected from the laser scanning projector, and a second plane mirror is configured to reflect the image reflected from the first plane mirror. A curved screen is configured to display the image reflected from the second plane mirror. A controller is configured to control output timing of laser beams outputted from the laser scanning projector based on a shape of the curved screen.

### CROSS-REFERENCE TO RELATED APPLICATION

This application claims the benefit of priority to Korean Patent Application No. 10-2013-0148729 filed in the Korean Intellectual Property Office on Dec. 2, 2013, the entire contents of which are incorporated herein by reference.

### TECHNICAL FIELD

The present disclosure relates to a curved display apparatus. More particularly, the present disclosure relates to a curved display apparatus mounted in a vehicle.

BACKGROUND

Various input devices, such as a keypad, a jog dial, and a touch screen, have been used to control various functions of a vehicle. Recently, attempts have been made to apply a touch display apparatus to a cluster or an audio-video-navigation (AVN) system of the vehicle in order to improve user's touch operation and vehicle design. A rear surface projection type touch display apparatus installed at curved surfaces in a vehicle has been developed. The rear surface projection type touch display apparatus uses a projector which is disposed in a rear surface of a curved screen to project an image.

When a digital light processing (DLP) type projector is used, an aspherical mirror should be provided between the curved screen and the projector because the projector has a constant focal distance. That is, an aspherical mirror corresponding to a curved screen shape need to be manufactured. In the case that the aspherical mirror is manufactured in accordance with the shape (i.e., curvature value) of the curved screen, manufacturing costs are increased.

The above information disclosed in this Background section is only for enhancement of understanding of the background of the disclosure, and therefore it may contain information that does not form the prior art that is already known in this country to a person of ordinary skill in the art.

### SUMMARY

The present disclosure has been made in an effort to provide a curved display apparatus for a vehicle having advantages of using a plane mirror instead of an aspherical mirror.

According to an exemplary embodiment of the present disclosure, a curved display apparatus for a vehicle includes a laser scanning projector projecting an image onto a predetermined projection area. A first plane mirror may reflect the image projected from the laser scanning projector, and a second plane mirror may reflect the image reflected from the first plane mirror. A curved screen may display the image reflected from the second plane mirror. A controller may control output timing of laser beams outputted from the laser scanning projector based on a shape of the curved screen.

The laser scanning projector may include a laser generator configured to output laser beams, a laser combiner configured to combine the laser beams projected from the laser generator, and a microelectromechanical systems (MEMS) scanner configured to project the image onto the predetermined projection area by scanning the laser beams.

The laser combiner may include a plurality of collimator lenses that are disposed in each of projection directions of the laser beams projected from the laser generator, and a plurality of dichroic mirrors corresponding to each of the projection directions of the laser beams projected from the plurality of collimator lenses.

The MEMS scanner may include a MEMS mirror scanning the laser beams.

The controller may control a direction of the laser beams scanned by the MEMS mirror according to a curvature value of the curved screen.

The laser generator may include a red laser source configured to project a red laser beam, a green laser source configured to project a green laser beam, and a blue laser source configured to project a blue laser beam.

The laser generator may further include an infrared laser source configured to project an infrared laser beam.

The curved display apparatus may further include an infrared camera photographing an infrared image reflected from the curved screen, and an application driver executing an application function according to control instructions of the controller, wherein the controller may determine a touched position on the curved screen based on the infrared image.

The image displayed on the curved screen may include a user interface configured with a plurality of selectable objects, and if the touched position corresponds to any one of the plurality of objects, the controller may generate control instructions for operating an application function mapped to the selected object.

According to an exemplary embodiment of the present disclosure, there is no need to manufacture the aspherical mirror corresponding to the shape of the curved screen. Accordingly, as only plane mirrors are used, the production cost is reduced. Images can be displayed without distortion based on curvature information of the curved screen thereby being applicable to various curved screens.

In addition, by using the laser scanning projector, an additional device to match a focal point is not necessary.

### BRIEF DESCRIPTION OF THE DRAWINGS

FIG. 1 is a schematic diagram of a curved display apparatus for a vehicle according to an exemplary embodiment of the present disclosure.

FIG. 2 is a schematic diagram of a laser scanning projector according to an exemplary embodiment of the present disclosure.

FIGS. 3 and 4 are drawings for explaining a principle of displaying an image without distortion according to an exemplary embodiment of the present disclosure.

FIG. 5 is a conceptual diagram illustrating an image displayed on a curved screen according to an exemplary embodiment of the present disclosure.

### DETAILED DESCRIPTION

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

Further, since each component shown in the drawings is arbitrarily illustrated for easy description, the present disclosure is not particularly limited to the component illustrated in the drawings.

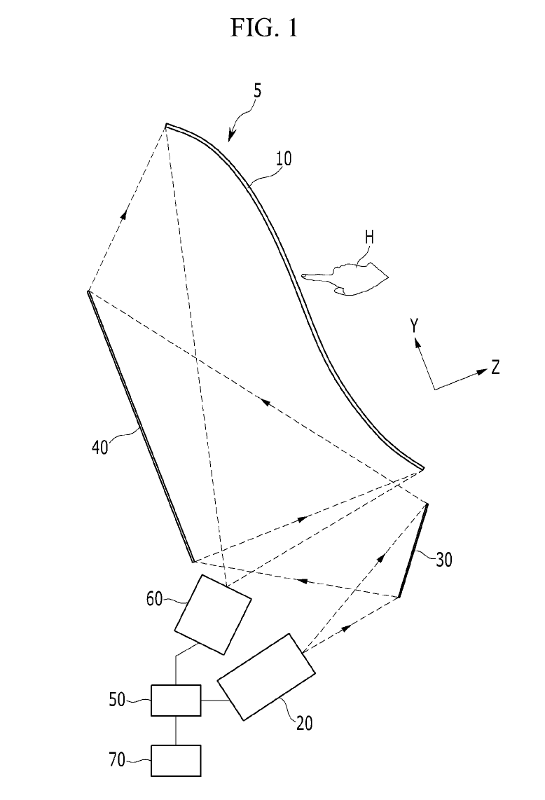

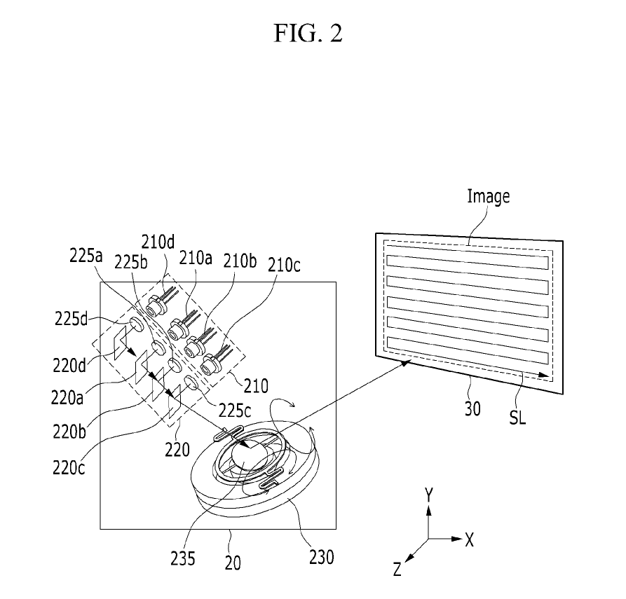

FIG. 1 is a schematic diagram of a curved display apparatus for a vehicle according to an exemplary embodiment of the present disclosure. FIG. 2 is a schematic diagram of a laser scanning projector according to an exemplary embodiment of the present disclosure.

As shown in FIGS. 1 and 2, a curved display apparatus 5 according to an exemplary embodiment of the present disclosure includes a curved screen 10, a laser scanning projector 20, a first plane mirror 30, a second plane mirror 40, and a controller 50.

Throughout the specification, the axis of the horizontal direction of an image outputted from the laser scanning projector 20 is denoted as an x-axis, and the axis of the vertical direction of the image is denoted as a y-axis.

The curved display apparatus 5 may be installed in a dashboard of a vehicle according to an interior design of the vehicle.

Images are projected from the laser scanning projector 20 onto the curved screen 10, and may be visually recognized by a viewer such as a driver.

The images may include instrument panel information, route guidance information, road information, and the like.

The laser scanning projector 20 includes a laser generator 210, a laser combiner 220, and a microelectromechanical systems (MEMS) scanner 230.

The laser generator 210 may include a red laser source 210a projecting a red laser beam, a green laser source 210b projecting a green laser beam, and a blue laser source 210c projecting a blue laser beam. Each of the red laser source 210a, the green laser source 210b, and the blue laser source 210c projects laser beams according to control signals outputted from the controller 50. Such different laser beams are mixed to reproduce a variety of colors.

The laser generator 210 may further include an infrared laser source 210d projecting an infrared laser beam.

Because of a high directionality, the laser beam moves in a straight line and does not spread. When using the laser beam, it is possible to achieve a pure color of an intensive single wavelength even with low power according to characteristics of the laser beam. Accordingly, images having a high quality can be provided regardless of a distance between the laser scanning projector 20 and the curved screen 10 because it does not need to match a focal point.

The laser combiner 220 combines laser beams that are projected from the laser generator 210. The laser combiner 220 transmits the laser beams outputted from the laser generator 210 to the MEMS scanner 230 through a single path.

The laser combiner 220 includes a plurality of collimator lenses 225a, 225b, and 225c, and a plurality of dichroic mirrors 220a, 220b, and 220c.

The plurality of collimator lenses 225a, 225b, and 225c are disposed in a projection direction of the laser beams projected from the laser generator 210. The plurality of collimator lenses 225a, 225b, and 225c refract the laser beams to generate parallel laser beams.

A dichroic mirror reflects laser beams only in a specific frequency band and passes laser beams of frequencies other than the specific frequency band. In detail, the dichroic mirror 220a corresponding to the projection direction of the red laser source 210a reflects laser beams of a red frequency band and passes laser beams of frequencies other than the red frequency band. The dichroic mirror 220b corresponding to the projection direction of the green laser source 210b reflects laser beams of a green frequency band and passes laser beams of frequencies other than the green frequency band. The dichroic mirror 220c corresponding to the projection direction of the blue laser source 210c reflects laser beams of a blue frequency band and passes laser beams of frequencies other than the blue frequency band.

Each of the dichroic mirrors 220a, 220b, and 220c reflects laser beams toward the MEMS scanner 230.

The laser combiner 220 may further include a collimator lens 225d and a dichroic mirror 220d corresponding to the projection direction of the infrared laser source 210d

The MEMS scanner 230 includes a MEMS mirror 235 scanning the laser beams along the x-axis direction and the y-axis direction and a driving portion (not shown) connected with the controller 50. The driving portion rotates the MEMS mirror 235 with respect the x-axis or the y-axis according to driving signals outputted from the controller 50. The MEMS mirror 235 projects images onto a predetermined projection area by scanning laser beams.

The controller 50 is connected to the laser generator 210 and the MEMS scanner 230 and may be implemented with one or more microprocessors executed by a predetermined program. The predetermined program may include a series of commands for performing each step included in a method for controlling the laser scanning projector 20 to display the images according to an exemplary embodiment of the present disclosure.

The controller 50 outputs control signals to each of the laser sources 210a, 210b, 210c, and 210d to blink the laser beams. The controller 50 outputs the driving signals to the MEMS scanner 230 so as to control the direction of the laser beams which are reflected by the MEMS mirror 235, such that the laser beams form a scanning line SL.

The controller 50 controls the laser scanning projector 20, such that the laser scanning projector 20 projects the laser beams, which form an image on a reflection surface of the first plane mirror 30. In detail, each pixel of the image is formed on the reflection surface of the first plane mirror 30 by scanning the blinked laser beams. One frame time (i.e., the time taken for the MEMS mirror 235 to return to the original position when laser beams sequentially scanned according to the sequential scanning technique) may be 1/60 of a second but is not limited thereto.

The image formed on the first plane mirror 30 is reflected toward the second plane mirror 40. The second plane mirror 40 reflects the laser beams reflected from the first plane mirror 30 toward the curved screen 10.

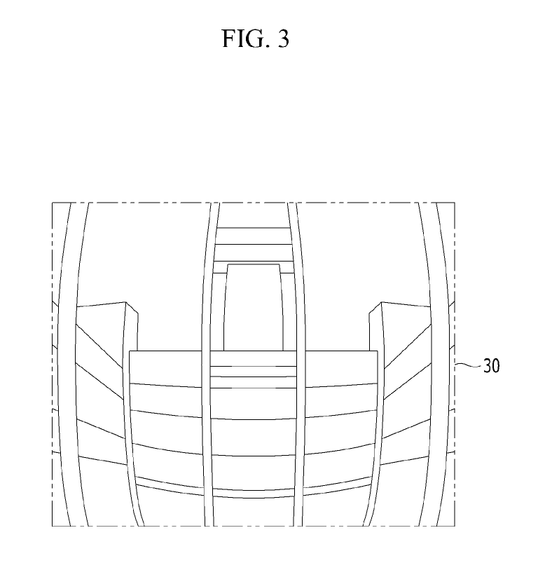

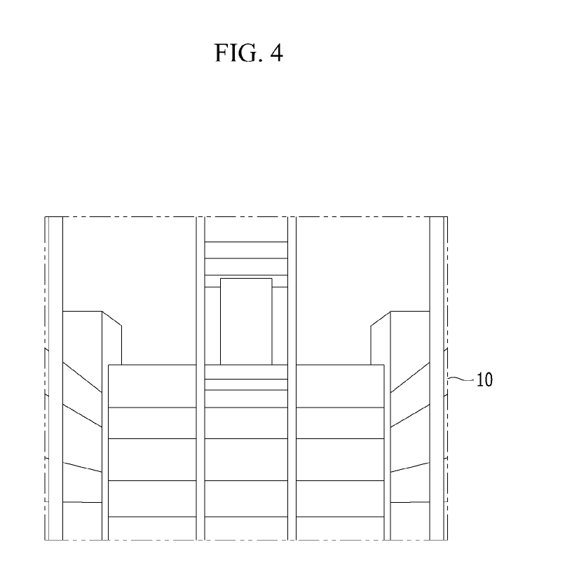

The controller 50 controls output timing of the laser beams outputted from the laser scanning projector 20 based on the shape of the curved screen 10. That is, the controller 50 controls the direction of the laser beams scanned by the MEMS mirror 235 according to the curvature value of the curved screen 10. For example, the image formed on the first plane mirror 30 is distorted as shown in FIG. 3, but the image formed on the curved screen 10 is displayed to the viewer without distortion as shown in FIG. 4.

In addition, by using the first plane mirror 30, the path depth of a laser beam required for displaying an image on the curved screen 10 can be controlled so that the size of the curved display apparatus 5 is reduced.

The curved display apparatus 5 according to an exemplary embodiment of the present disclosure may further include an infrared camera 60 photographing an infrared image, and an application driver 70 executing an application function according to control instructions of the controller 50. Infrared laser beams projected from the laser scanning projector 20 are reflected toward the second plane mirror 40 via the first plane mirror 30. The second plane mirror 40 reflects the infrared laser beams toward the curved screen 10.

When a user's hand H touches any position on the curved screen 10, infrared laser beams are reflected and the infrared camera 60 photographs the reflected infrared image.

The controller 50 determines a touched position based on the infrared image. When the user's hand H touches the curved screen 10, the controller 50 determines the touched position.

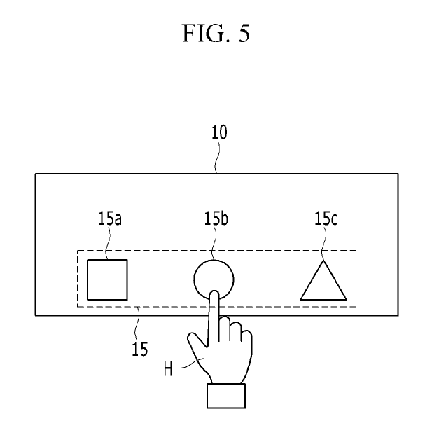

Referring to FIG. 5, the image displayed on the curved screen 10 may include a user interface configured with a plurality of objects 15 that are selectable. Here, an object refers to information that is selected and controlled by a user. For example, the object may be an image, an icon, a folder icon, text, content, a list, and the like.

The user may select a desired object 15b among the plurality of objects 15a, 15b, and 15c. At this time, the controller 50 may generate the control instructions to operate the application function mapped to the selected object 15b, and output the control instructions to the application driver 70. Here, the application function may be one of various application functions of a plurality of electronic devices (e.g., an air conditioner or a navigation device) provided in the vehicle.

As described above, according to an exemplary embodiment of the present disclosure, there is no need to manufacture the aspherical mirror corresponding to the shape of the curved screen 10. Accordingly, as only plane mirrors are used, the production cost is reduced. Images can be displayed without distortion based on curvature information of the curved screen 10 thereby being applicable to various curved screens.

In addition, by using the laser scanning projector 20, an additional device to match a focal point is not necessary.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A curved display apparatus for a vehicle, comprising:
a laser scanning projector projecting an image onto a projection area;
a first plane mirror configured to reflect the image projected from the laser scanning projector;
a second plane mirror configured to reflect the image reflected from the first plane mirror;
a curved screen configured to display the image reflected from the second plane mirror; and
a controller configured to control output timing of laser beams outputted from the laser scanning projector based on a shape of the curved screen.

2. The curved display apparatus of claim 1, wherein the laser scanning projector comprises:
a laser generator configured to output the laser beams;
a laser combiner configured to combine the laser beams projected from the laser generator; and
a microelectromechanical systems (MEMS) scanner configured to project the image onto the projection area by scanning the laser beams.

3. The curved display apparatus of claim 2, wherein the laser combiner comprises:
a plurality of collimator lenses that are disposed in each of projection directions of the laser beams projected from the laser generator; and
a plurality of dichroic mirrors corresponding to each of the projection directions of the laser beams projected from the plurality of collimator lenses.

4. The curved display apparatus of claim 2, wherein the MEMS scanner comprises a MEMS mirror scanning the laser beams.

5. The curved display apparatus of claim 4, wherein the controller controls a direction of the laser beams scanned by the MEMS mirror according to a curvature value of the curved screen.

6. The curved display apparatus of claim 2, wherein the laser generator comprises:
a red laser source configured to project a red laser beam;
a green laser source configured to project a green laser beams; and
a blue laser source configured to project a blue laser beam.

7. The curved display apparatus of claim 6, wherein the laser generator further comprises an infrared laser source configured to project an infrared laser beam.

8. The curved display apparatus of claim 7, further comprising:
an infrared camera photographing an infrared image reflected from the curved screen; and
an application driver executing an application function according to control instructions of the controller,
wherein the controller determines a touched position on the curved screen based on the infrared image.

9. The curved display apparatus of claim 8, wherein the image displayed on the curved screen comprises a user interface configured with a plurality of selectable objects, and if the touched position corresponds to any one of the plurality of objects, the controller generates the control instructions for operating the application function mapped to a selected object.

10. The curved display apparatus of claim 3, wherein the dichroic mirror reflects the laser beams only in a specific frequency band and passes laser beams of frequencies other than the specific frequency band.

11. The curved display apparatus of claim 1, wherein the shape of the surved screen is represented with a curvature value of the curved screen.
